(19) United States
(12) Patent Application Publication
(10) Pub. No.: US 2004/0024544 A1
(43) Pub. Date: Feb. 5, 2004

(54) Method of reducing energy waste by monitoring steam traps

(76) Inventors: Rodger A. Guebert, St. Louis, MO (US); Thomas S. Hughes, Ballwin, MO (US); Michael L. Smith, Chesnee, SC (US); Frank W. Sospenzi, Naperville, IL (US)

Correspondence Address: Ondeo Nalco Company, Patent & Licensing Department, Ondeo Nalco Center, Naperville, IL, 60563-1198, US

(21) Appl. No.: 10/209,024

(22) Filed: Jul. 31, 2002

(51) Int. Cl. G06F 19/00; G01B 5/00; G01B 3/00

(52) U.S. Cl. 702/33

(57) ABSTRACT

A method of monitoring steam traps to identify which steam traps are malfunctioning is described and claimed. The method involves surveying the building to locate all the steam traps, identifying where to place the sensors to monitor the steam traps of interest, placing the sensors in appropriate locations, collecting the signals from each sensor in a collection point, monitoring the collected signals to identify which steam traps are not operating as desired and taking corrective action regarding those steam traps that are not operating as desired. The method enables the operator of the industrial water system using steam traps to be able to reduce the cost of wasted energy in lost steam.

### FIELD OF INVENTION

This invention is in the field of minimizing energy losses in any industry that uses steam. Specifically, this invention is in the field of monitoring steam traps to identify which steam traps are malfunctioning which enables the operator of the industrial water system to be able to reduce the cost of wasted energy in lost steam.

### BACKGROUND OF THE INVENTION

Steam traps are automatic valves that are in most steam systems to remove condensate, air and other non-condensable gases from the steam line. Operational problems will occur if the condensate, air and non-condensable gases are not removed from the system. In addition to their function of removing condensate from the steam line, steam traps also function to minimize the amount of steam they let blow by. This is a critical function in terms of reducing energy costs because it is not possible for an industrial process, using a vented receiver for condensate to recapture the energy value of steam that “blows by” a malfunctioning steam trap.

In addition to the loss of energy, steam blowing by a malfunctioning steam trap also causes other significant financial losses. These financial losses include: the cost to produce the steam in dollars and in energy; the value of the lost condensate return; the value of increased make-up water requirements; and the value of feedwater pretreatment, including both mechanical and chemical pretreatment, to treat the additional make-up water.

The current practices for monitoring steam traps include the following:

A physical inspection of each and every one of the steam traps to verify they are in proper working order. This is expensive; because it is a very labor-intensive method which requires experienced inspectors to properly evaluate the steam trap operation. Furthermore, steam traps could be blowing by for sometime before they are discovered which is a problem with all monitoring techniques that are not automatic.

Another type of monitoring method is for someone to listen to the steam traps, using a mechanical stethoscope or ultrasonic sound meter. Like physically inspecting the steam traps, this is a very labor-intensive method and requires experienced inspectors to properly evaluate the steam trap operation.

Another type of monitoring method is for someone to measure the temperature of the steam trap. Current methods include taking the temperature of each steam trap manually; which is very expensive due to the labor costs. Another current method of monitoring the temperature is using specialized steam traps with built-in temperature sensors. One such “built-in” monitor steam trap is available as the SteamEye™ product from Armstrong International, Inc., 816 Maple Street, P.O. Box 408, Three Rivers Mich. 49093. These steam traps with built in temperature sensors are very expensive; relative to ordinary steam traps. In addition to the cost of the specialized steam traps there is an enormous labor cost associated with replacement of all of the sensors.

It would be desirable to have an additional method to monitor steam traps that did not require expensive and labor-intensive techniques.

### SUMMARY OF THE INVENTION

The first aspect of the claimed invention is a method of reducing energy waste by monitoring steam traps comprising:

(1) surveying the building to locate all existing steam traps;

(2) numbering all of the existing steam traps;

(3) creating a Master Steam Trap Blueprint showing the location of all the steam traps;

(4) deciding which steam traps to monitor;

(5) performing a site survey to determine exactly where to place each sensor so that the signal from each sensor can be collected;

(6) placing sensors in appropriate locations so that the steam traps of interest may be monitored;

(7) collecting the signal from each of said sensors in a collection point;

(8) monitoring the collected signals to identify which steam traps are not operating as desired; and

(9) taking corrective action regarding those steam traps that are not operating as desired.

The second aspect of the claimed invention is a method of reducing energy waste by remote monitoring of steam traps comprising:

(a) surveying the building to locate all existing steam traps;

(b) creating a Master Steam Trap Blueprint showing the location of all the steam traps;

(c) deciding which steam traps to monitor;

(d) performing a radio site survey to determine exactly where to place each sensors so that the signal from each sensor can be collected;

(e) placing sensors in appropriate locations so that the steam traps of interest may be monitored;

(f) collecting the signal from each of said sensors in a local computer which holds raw operating data from said sensors in an electronic format;

(g) coupling said local computer to an Internet server computer or, in the alternative, using a dedicated phone line to an Internet Service Provider to gain access to the Internet;

(h) transmitting said stored raw operating data via the world wide web using transmission methods to a remotely located Internet server computer;

(i) storing said raw operating data on said Internet server computer;

(j) manipulating said raw operating data into an analysis result;

(k) uploading the results of said analysis result to an Internet server in a format suitable for access and visualization with a web browser program; and

(l) reviewing the analysis result and taking corrective action regarding those steam traps that are not operating as desired.

### DETAILED DESCRIPTION OF THE INVENTION

Throughout this patent application the following terms have the indicated definitions:

“aka” means “also known as”.

Nalco refers to Ondeo Nalco Company, Ondeo Nalco Center, 1601 W. Diehl Road, Naperville Ill. 60563, telephone number (630) 305-1000.

The first aspect of the claimed invention is a method of reducing energy waste by monitoring steam traps comprising:

(1) surveying the building to locate all existing steam traps;

(2) numbering all of the existing steam traps;

(3) creating a Master Steam Trap Blueprint showing the location of all the steam traps;

(4) deciding which steam traps to monitor;

(5) performing a site survey to determine exactly where to place each sensor so that the signal from each sensor can be collected;

(6) placing sensors in appropriate locations so that the steam traps of interest may be monitored;

(7) collecting the signal from each of said sensors in a collection point;

(8) monitoring the collected signals to identify which steam traps are not operating as desired; and

(9) taking corrective action regarding those steam traps that are not operating as desired.

The first step in the method of this instant claimed invention is to survey the building to locate and identify the type of all the existing steam traps present in the building. This survey typically begins with reviewing the piping blueprints for the building. Preferably the piping blueprints reviewed should be those labeled “As Built” as compared to those labeled “Proposed” because, as is known to ordinary people of skill in the art of piping blueprints, that the “As Built” piping blueprints better reflect the actual structure that was built and the actual equipment that was placed in that structure. Whatever piping blueprints are available, the blueprint with the best information should be chosen as the basis for the “Master Steam Trap Blueprint” that is to be created. If no piping blueprints are available for review, then a survey of the building to physically locate the steam traps and pipes will be necessary.

After the piping blueprints have been reviewed or it has been determined that there are no piping blueprints to review, the physical survey process begins with an on-site inspection of the building. All steam traps need to be physically located; from the roof to the basement. The inspection typically, though not always, starts with the roof and proceeds downward through the building. All steam traps located should be checked against the best available blueprint and the actual location of the steam traps and any discrepancy between the blueprint and the actual building should be noted on the Master Steam Trap Blueprint that is being created to show where all the steam traps are by representing the steam traps pictorially.

In surveying the building for steam traps, it is recommended, though not required, that the different types of steam traps and pipes be marked down with their own particular symbol to make it easier to distinguish between them. Of course it is possible to use just one symbol to indicate a steam trap is present, without being specific about what type of steam trap is being used. However, because there are as many different symbols for steam traps and pipes as there are people working on piping blueprints, it is also possible to identify what type of steam trap is present by using a unique symbol for each type of steam trap. All symbols are acceptable as long as they are unambiguous. One set of acceptable useful symbols for certain steam traps is the following:

| | |
|---|---|
| [symbol] | inverted bucket steam trap |
| ▪ | float steam trap |
| ¤ | disc steam trap |
| ∝ | thermostatic wafer steam trap |

When the use of additional specific identification symbols for “specialized” steam traps becomes necessary or desirable, then individual symbols for specific steam traps can be created by the method operator. The only criteria for selection and use of these symbols is that a master “key” be kept readily available, so people not familiar with the method of the instant claimed invention can still read and understand the location of each steam trap.

After all the steam traps have been located, then a decision has to be made about what steam traps to monitor. In contrast to earlier methods of monitoring steam traps, which required that each and every steam trap have a monitor built into it the method of the instant claimed invention does not require special sensors be incorporated directly into the steam trap. With the method of the instant claimed invention a sensor can be used to monitor a condensate line which has multiple steam traps feeding into it. In this way, when an elevated temperature or noise is detected, this indicates that at least one steam trap feeding into the condensate line is malfunctioning. Then a follow-up inquiry, perhaps using just a basic heat gun, can be used to determine which steam trap is malfunctioning and that steam trap can be then targeted for early replacement.

The next decision involves the type of sensor to be placed to each location. Many different types of sensors are available, but the two most useful are temperature sensors and acoustic sensors. The temperature sensor senses a malfunctioning steam trap by detecting an elevated temperature, meaning a trap is allowing steam through. An acoustic sensor can be used to detect a malfunctioning steam trap by detecting a loud noise, indicative of steam blasting through a stuck open steam trap.

Temperature and acoustic sensors are available commercially from many companies, including, but not limited to:

Armstrong International, Inc., 816 Maple Street, Three Rivers, Mich. 49093; Spirax Sarco, Inc., 1150 Northpoint Blvd., Blythewood, S.C. 29016; Quality Instruments, Inc., 4315 Regnas Avenue, Suite “B”, Tampa Fla. 33617, (888) 345-7885 (telephone), (813) 984-8755 (fax); George Fischer, Inc., 2882 Dow Avenue, Tustin Calif. 92780-7285, (714) 731-8800 (telephone), (714) 731-6201 (fax); GlobalSpec, Inc. 350 Jordan Road, Troy N.Y. 12180, (518) 880-0200 (telephone), (518) 880-0250 (fax). The decision must be made for each location regarding whether to affix a temperature monitor or an acoustic monitor or both a temperature and acoustic monitor.

The decision next has to be made as to exactly where each sensor is placed. For each and every sensor it is necessary to place the sensor in a location where it is possible to collect the signal from the sensor for further processing. The determination of where to place each sensor is influenced by the method chosen to collect the signals. For example if the collection of the signals involves using a radio signal, then a “radio survey” of the location must be done in order to determine whether it will be possible to collect signals in view of possible interference from other equipment located in the facility. However the survey is conducted, at the conclusion of the survey the location where each sensor will be placed will be identified and marked.

After the decision is made where to place a monitor, the location is marked on the Master Blueprint. Then, the location is marked on the actual piece of equipment using either red tape or a black permanent marker.

In order to affix a temperature sensor such that it can measure several steam traps at once, the sensor is typically secured to the low pressure (hereinafter “LP”) condensate return line. Normally one temperature sensor will monitor several steam traps.

The pre-mounting procedure is to clean the LP condensate line with a steel wire brush, degreaser solvent and/or sandpaper. An area approximately 4 inches wide across the complete circumference of the pipe is the preferred size of the area to be cleaned. After being cleaned, the pipe surface should be wiped dry with a clean cloth.

A suitable adhesive for high temperature adhesion to metal surfaces, is a commercial product such as Permabond High-Temperature Adhesive™, which is available from McMaster-Carr, P.O. Box 4355, Chicago, Ill. 60680-4355, (703) 833-0300 or (404) 346-7000 or (630) 833-0300, is then used to adhere the sensor to the pipe. The adhesive may be applied by putting a few drops of adhesive on the sensor itself and a couple of drops on the pipe where the sensor is to be mounted. The sensor must then immediately be glued to the pipe. To ensure good adhesion it is recommended that the sensor actually be held in place against the pipe for approximately 30 seconds.

The pipe is then wrapped using high temperature Thermosetting Glass Cloth Tape, also available from McMaster-Carr. The Permabond High-Temperature Adhesive™ and the high temperature Thermosetting Glass Cloth Tape™, were chosen because of their specific resistance to the high temperatures of the LP condensate return which can range between about 180° F. to about 280° F.

The Thermosetting Glass Cloth Tape™ is then wrapped several times around the pipe; making sure to overlap the temperature sensor. The tape helps insulate the sensor from environmental effects. If this temperature sensor is located in a high water area or in a high moisture/humidity environment which might cause the tape or glue to loosen, a large diameter stainless steel worm gear clamp can be used to secure the sensor over the tape. Using a clamp will help hold the sensor in place as well as contribute to the insulation of the sensor from the effects of the environment. If a clamp is used it is very important to not over tighten the clamp because overtightening the clamp could cause damage to the sensor.

The information from each sensor can be collected manually or by using many different types of equipment configurations. The manual collection of information from each sensor is labor intensive and it also takes a lot of time. Using equipment, such as hard wiring each sensor to a central personal computer in the facility or having each sensor broadcast it's signal continuously to either a hand held receiver or to a local collection point where all the signals are compiled, either manually or using a personal computer or some other form of collection device. The ability to transmit data to a collection point without requiring any hardwiring is the preferred way to conduct the method of the instant claimed invention.

When SensorWatch™ technology, available commercially from Xsilogy, Inc., San Diego, Calif., Telephone: 858-362-5000, (hereinafter “Xsilogy”) is available a SensorWatch™ survey kit is then used to determine where the SkyBeam™ transmitters, SkyHoppers™ and SkyRamps™ will be mounted.

A SkyBeam™ is a battery powered, 900 megahertz (“MHz”) spread spectrum RF transmitting device which can pull data signals from local sensors by one of the following means:

a) four industry standard 4-20 mA analog inputs;

b) a pulse frequency counter;

c) a S3L bus; and

d) Four Digital I/O inputs.

This device is powered by one 3.6V, size ‘C’ lithium inorganic battery. A SkyHopper™ is a radio repeater that ‘listens’ for the SkyBeam™ RF signal; catches and amplifies that signal, then retransmits it to the SkyRamp™ via 900 MHz spread spectrum RF.

A SkyRamp™ is an electronic data collection device that stores data between a local area network of spectrum radio sensing devices and the Internet. The SkyRamp™ transmits the electronic data through a working Internet link with one of three choices:

a) Ethernet running TCP/IP connected to the Internet;

b) A telephone line capable of supporting a dial up modem; and

c) BellSouth two-way wireless connection.

A SkyRamp™ is an electronic data collection device that stores data between a local area network of spectrum radio sensing devices and the Internet. The SkyRamp™ transmits the electronic data through a working Internet link with one of three choices:

d) Ethernet running TCP/IP connected to the Internet;

e) A telephone line capable of supporting a dial up modem; and

f) BellSouth two-way wireless connection.

This survey kit will pinpoint precisely where the SensorWatch™ equipment will need to be located for optimum performance of the Steam Trap Monitoring System.

Once the temperature sensor is attached to the pipe, the wires inside the SkyBeam™ are connected to the serial BUS port according to the instructions outlined in the installation manual.

Once wires have been connected to the SkyBeam™ each wire is tie-wrapped to a conduit, or a pipe or another stationary structure to secure it. Each SkyBeam™ has its own individual identification number and that SkyBeam™ will be attached to that specific LP condensate return line. Each line that has a SkyBeam™ attached to it will have a name connected to it, i.e. LP condensate, etc.

The next step is to confirm with Xsilogy that each SkyBeam is reporting to the SkyRamp™. SkyHoppers™ will be installed if necessary based on a survey that is conducted prior to installation of the SkyRamp™.

After installation of the SensorWatch™ equipment for the steam trap monitoring application, a signal name and identification sheet is forwarded to Xsilogy so the operator's web site can be configured and brought online. The operator of the industrial water system is assigned a user login name and password. The installer will log in as the operator to verify that the operators' user name and password works correctly site is up and running and functioning correctly.

At this point the operator of the industrial water system may then log on and see each LP condensate return line individually and what the temperature of that line is at any given time. Please note that the data can be displayed either as a graph or table format to be interpreted. Since the steam traps release hot condensate on a regular basis, the temperature of the piping will vary between a given temperature range. The way in which failing traps are identified is by reviewing the temperature trend of that system over the course of a week, month, or year. If the temperature differential rises for no specific reason, then the operator should check the traps associated with that particular sensor.

Methods of checking the steam traps include manual methods such as having an operator use a temperature gun or an acoustic monitor to double-check the information on the website. The steam traps can also be checked by installing a three way valve down stream of each trap to determine if the trap is allowing just condensate to pass or steam also. Experience with this method has shown that installing a three way valve is the only sure way to determine if the trap is failing.

After one or more of these methods are used to identify the failing steam traps, the steam traps can be repaired, or more likely, can be replaced. After the failing steam trap is repaired or replaced, the operator then checks the web site to determine if the sensors' differential temperature has come back into normal range. If not, there may be another trap that is still not performing properly.

The website gives the operator the ability to set up high and low limit alarms as well as compare one sensor's data to another. This compare feature has proven to be a very valuable tool to evaluate sensors that are located on condensate lines that are in identical applications or on identical machines. In this way, one machine's traps are fixed so it becomes a base line which the other systems are compared against.

If the alarm features are used, an e-mail or fax can be sent to notify the plant of the problem so the situation can be resolved. These alarms may also be sent to a pager or cell phone, providing that the cell phone has web capabilities or is capable of receiving email.

Once a trend has been established for that particular LP return line the operator can then determine when steam traps are opening or closing and/or failing. When the operator determines that a trap has failed on any particular line the operator will replace that trap and then go to the web site and create an “incident report” by completing the appropriate form. Once this form is completed this will start generating a cost savings per day for that particular steam trap that has been replaced for the amount of time that it would have gone unreplaced, but for the practicing of the method of the instant claimed invention.

On the website, the plant will input the cost to produce steam in the system. The server will take the failing trap data and interpret the cost the plant would have incurred if the steam trap were not repaired. The plant can then assign a time span to that steam trap which will figure the savings that the plant will realize for repairing the failed steam trap. This time span is an agreed upon amount of time that was determined by the following rationale:

if the steam trap failed without using the method of the instant claimed invention, then by using the plant's old methods of finding a failing steam trap the steam trap would have leaked steam for a given amount of time before it was fixed. Because the method of the instant claimed invention found the steam trap failing more quickly, then the savings that are associated with that given amount of time is the savings that the computer will calculate and display on the website. These savings for that particular steam trap will be allocated over the life that the steam trap would have been failing if the method of the instant claimed invention would have not been practiced. These savings can be viewed by anyone in the organization that has website access.

One other interesting feature of the method of the instant claimed invention is that when the method of the instant claimed invention is practiced, the facility practicing this method develops the ability to trouble shoot problems in the plant. Since it has never been an industry practice to monitor the temperature of the condensate system in the past, by practicing the method of the instant claimed invention it is now possible to analyze problems in the LP condensate line that facilities never knew existed.

These problems can include undetected problems with valves that are malfunctioning. For example, many condensate lines have a back pressure valve that is used to maintain a consistent back pressure on the condensate system in the curing area of the plant. Whenever this backpressure valve fluctuates, then a number of operational problems occur. Using the method of the instant claimed invention the problem with the valve can be detected and the valve controller replaced, which causes the operational problems to go away. After the valve's controller is replaced, the operational problems that are caused by the malfunctioning valve are solved.

Although the invention has been described in detail for the purpose of illustration, it is to be understood that such detail is solely for that purpose and that numerous modifications, alterations and changes can be made therein by those skilled in the art without departing from the spirit and scope of the invention except as it may be limited by the claims. All changes which come within the meaning and range of equivalency of the claims are to be embraced within their scope.

What is claimed is:

1. A method of reducing energy waste by monitoring steam traps comprising:
(1) surveying the building to locate all existing steam traps;
(2) numbering all of the existing steam traps;
(3) creating a Master Steam Trap Blueprint showing the location of all the steam traps;
(4) deciding which steam traps to monitor;
(5) performing a site survey to determine exactly where to place each sensor so that the signal from each sensor can be collected;
(6) placing sensors in appropriate locations so that the steam traps of interest may be monitored;
(7) collecting the signal from each of said sensors in a collection point;
(8) monitoring the collected signals to identify which steam traps are not operating as desired; and
(9) taking corrective action regarding those steam traps that are not operating as desired.

2. A method of reducing energy waste by remote monitoring of steam traps comprising:
(a) surveying the building to locate all existing steam traps;
(b) creating a Master Steam Trap Blueprint showing the location of all the steam traps;
(c) deciding which steam traps to monitor;
(d) performing a radio site survey to determine exactly where to place each sensors so that the signal from each sensor can be collected;
(e) placing sensors in appropriate locations so that the steam traps of interest may be monitored;
(f) collecting the signal from each of said sensors in a local computer which holds raw operating data from said sensors in an electronic format;
(g) coupling said local computer to an Internet server computer or, in the alternative, using a dedicated phone line to an Internet Service Provider to gain access to the Internet;
(h) transmitting said stored raw operating data via the world wide web using transmission methods to a remotely located Internet server computer;
(i) storing said raw operating data on said Internet server computer;
(j) manipulating said raw operating data into an analysis result; and
(k) uploading the results of said analysis result to an Internet server in a format suitable for access and visualization with a web browser program;
(l) reviewing the analysis result and taking corrective action regarding those steam traps that are not operating as desired.
